(19) United States
(12) Patent Application Publication
(10) Pub. No.: US 2026/0127416 A1
(43) Pub. Date: May 7, 2026

(54) BLENDED OUTPUT GENERATION IN GENERATIVE ARTIFICIAL INTELLIGENCE MODELS

(71) Applicant: QUALCOMM Incorporated, San Diego, CA (US)

(72) Inventors: Aniket ROY, San Diego, CA (US); Shubhankar Mangesh BORSE, San Diego, CA (US); Shreya KADAMBI, San Diego, CA (US); Ankita NAYAK, Milpitas, CA (US); Risheek GARREPALLI, San Diego, CA (US); Hyojin PARK, San Diego, CA (US); Debasmit DAS, San Diego, CA (US); Munawar HAYAT, San Diego, CA (US); Fatih Murat PORIKLI, San Diego, CA (US); Shweta MAHAJAN, San Diego, CA (US)

(21) Appl. No.: 18/940,486

(22) Filed: Nov. 7, 2024

(51) Int. Cl. G06N 3/0475; G06N 3/096

(52) U.S. Cl. CPC G06N 3/0475; G06N 3/096

(57) ABSTRACT

Techniques and apparatus for generating content with multiple specified attributes using a generative artificial intelligence model are described. An example method generally includes receiving a request to generate an output of a machine learning model, the request specifying a plurality of attributes of the output of the machine learning model. A set of intermediate outputs is generated via a plurality of adapters of the machine learning model. Each respective adapter of the plurality of adapters may be associated with a respective attribute of the specified plurality of attributes and include a respective mask in a low-rank dimension associated with the respective adapter. The set of intermediate outputs is merged into a combined output of the plurality of adapters of the machine learning model, and the output of the machine learning model is generated based on the combined output of the plurality of adapters.

### INTRODUCTION

Aspects of the present disclosure relate to generative artificial intelligence models.

Generative artificial intelligence models can be used in various environments in order to generate a response to an input prompt (also referred to as a query or an input). For example, generative artificial intelligence models can be used in chatbot applications in which large language models (LLMs) are used to generate an answer, or at least a response, to an input prompt. Other examples in which generative artificial intelligence models can be used include a latent diffusion model, in which a model generates an image or stream of images (e.g., video content) from an input text description of the content of the desired image or stream of images, decision transformers, in which future actions are predicted based on sequences of prior actions within a given environment, or the like.

Generally, generative artificial intelligence models have many (e.g., millions or billions) of parameters, resulting in models that are large in size and incur a significant computational expense to train the model. Further, once trained, generative artificial intelligence models are often difficult (or impossible) to fine-tune, as the vast number of parameters makes overfitting (where the model fits too closely to the training data, resulting in loss of accuracy and generalization for runtime data) a major challenge (e.g., potentially relying on tremendous amounts of fine-tuning data to prevent overfitting).

To allow for generative artificial intelligence models to be fine-tuned or modified, smaller model adapters may be trained for large models. For example, adapters may be trained to improve or enable video generation based on desired appearances, movement, and the like.

### BRIEF SUMMARY

Certain aspects of the present disclosure provide a method for generating content using a generative artificial intelligence model. An example method generally includes receiving a request to generate an output of a machine learning model, the request specifying a plurality of attributes of the output of the machine learning model. A set of intermediate outputs is generated via a plurality of adapters of the machine learning model. Each respective adapter of the plurality of adapters may be associated with a respective attribute of the specified plurality of attributes and include a respective mask in a low-rank dimension associated with the respective adapter. The set of intermediate outputs is merged into a combined output of the plurality of adapters of the machine learning model, and the output of the machine learning model is generated based on the combined output of the plurality of adapters.

Certain aspects of the present disclosure provide a method for training a generative artificial intelligence model to generate content. An example method generally includes receiving a first data set associated with a first attribute for which a machine learning model is to be trained and a second data set associated with a second attribute for which the machine learning model is to be trained. A first adapter of the machine learning model is trained to finetune outputs in accordance with the first attribute based on the first data set, the first adapter including a first mask in a low-rank dimension associated with the first adapter. A second adapter of the machine learning model is trained to finetune outputs in accordance with the second attribute based on the second data set, the second adapter including a second mask in a low-rank dimension associated with the second adapter, such that an output of the first adapter is orthogonal to an output of the second adapter. A merged adapter is trained, with the merged adapter comprising the trained first adapter and the trained second adapter. The machine learning model is deployed with the trained merged adapter.

Certain aspects of the present disclosure provide a method for generating content using a generative artificial intelligence model. An example method generally includes receiving a request to generate an output of a machine learning model, the request specifying a plurality of attributes for the output of the machine learning model. A set of intermediate outputs is generated via a plurality of adapters of the machine learning model. Generally, each respective adapter of the plurality of adapters is associated with a respective attribute of the specified plurality of attributes and is trained based on a cycle-consistency loss between different attributes of the specified plurality of attributes. The set of intermediate outputs is merged into a combined output of the plurality of adapters of the machine learning model, and the output of the machine learning model is generated based on the combined output of the plurality of adapters.

Certain aspects of the present disclosure provide a method for training a generative artificial intelligence model to generate content. An example method generally includes receiving a first data set associated with a first attribute of an output for which a machine learning model is to be trained and a second data set associated with a second attribute of the output for which the machine learning model is to be trained. A first adapter of the machine learning model is trained to finetune outputs in accordance with the first attribute based on the first data set, and a second adapter of the machine learning model is trained to finetune outputs in accordance with the second attribute based on the second data set. A merged adapter is trained based on a cycle-consistency loss between the first attribute and the second attribute, the merged adapter comprising the first adapter and the second adapter. The machine learning model is deployed with the trained merged adapter.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict only certain aspects of this disclosure and are therefore not to be considered limiting of the scope of this disclosure.

FIG. 1 depicts an example of generating a blended (or merged) output using adapters for a generative artificial intelligence model trained on different attributes of the blended output, according to certain aspects of the present disclosure.

FIG. 2 illustrates a pipeline for generating a blended output of different adapters trained on different attributes of the blended output, each adapter of the different adapters being associated with a mask in a low-rank dimension of the adapter, according to certain aspects of the present disclosure.

FIG. 3 illustrates rank constraints associated with layers of a generative artificial intelligence model including adapters associated with different attributes of a blended output, according to certain aspects of the present disclosure.

FIGS. 4A and 4B illustrate pipelines for training a generative artificial intelligence model based on a cycle-consistency loss to generate a blended output using adapters associated with different attributes of the blended output, according to certain aspects of the present disclosure.

FIG. 5 illustrates example operations for generating an output of a generative artificial intelligence model based on defined attributes and adapters associated with the defined attributes, according to certain aspects of the present disclosure.

FIG. 6 illustrates example operations for training a generative artificial intelligence model to generate a blended output based on defined attributes and adapters associated with the defined attributes, according to certain aspects of the present disclosure.

FIG. 7 illustrates example operations for generating an output of a generative artificial intelligence model based on defined attributes and adapters associated with the defined attributes, according to certain aspects of the present disclosure.

FIG. 8 illustrates example operations for training a generative artificial intelligence model to generate a blended output based on defined attributes and adapters associated with the defined attributes, according to certain aspects of the present disclosure.

FIG. 9 depicts an example processing system configured to perform various aspects of the present disclosure.

FIG. 10 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatus, methods, processing systems, and computer-readable mediums for generating outputs blending specified attributes of the outputs using generative artificial intelligence models.

Generative artificial intelligence models can be used to generate a variety of outputs, such as textual outputs (e.g., via generative language models), multimedia outputs (e.g., via generative vision models), and the like. In some scenarios, generative artificial intelligence models may be structured as multi-modal models, such as text-to-image generative models that receive a textual input defining the attributes (e.g., content and style) of an image output to be generated by the generative model and output the image output in accordance with the attributes of the output defined in the textual input. However, it remains highly challenging to reproduce specific objects, appearances, and/or camera or object movements based on text prompts alone.

To train a generative artificial intelligence model and allow for these models to generate blended outputs that comply with various attributes specified in an input prompt, adapters (e.g., low-rank adaptation (LoRA) adapters) can be used to adapt a base generative model to perform a task. For example, a base generative artificial intelligence model, which may be frozen (e.g., have weights that are frozen), may be adapted via the use of adapters that allow for a base model to be modified to perform tasks for which the base model was not trained without retraining the base model itself. In some aspects, where multiple attributes are identified in an input prompt, multiple adapters may be used to generate an output of the machine learning model that is responsive to the input prompt (e.g., based on combining the outputs of these adapters, using learnable orthogonal masks in the weight space of the adapters to generate dissimilar intermediate outputs that can be combined). However, these techniques may be computationally inefficient, as these techniques may increase the number of parameters to be processed by the generative artificial intelligence model. Further, because some attributes, such as style and content, may be intertwined (e.g., dependent) attributes instead of orthogonal (e.g., independent) attributes, these techniques may not generate outputs that satisfy the attributes specified in a request to generate an output of the machine learning model.

Certain aspects of the present disclosure provide techniques and apparatus for training and using machine learning models to efficiently generate outputs, such as visual content, according to attributes defined in a request to generate an output of a machine learning model. As discussed in further detail herein, a generative machine learning model may include adapters associated with each of a plurality of attributes defining an output of the machine learning model. To allow for efficient generation of an output that complies with the attributes defined in the request, the adapters of the machine learning model may use learnable masks in a low-rank dimension of the adapter and may be trained based on a cycle-consistency loss associated with the application and removal of attributes from a base sample of content. By doing so, certain aspects of the present disclosure may allow for accurate generation of content that conforms to the attributes (which may be intertwined) specified in a request while minimizing, or at least reducing, the number of parameters on which operations are performed by the machine learning model during inferencing, as these parameters may be masked and minimized in a space associated with a low-rank dimensionality instead of a space associated with a higher-rank dimensionality (e.g., the dimensionality of the base model).

### Example Content Generation Using Generative Artificial Intelligence Models and Attribute-Specific Adapters

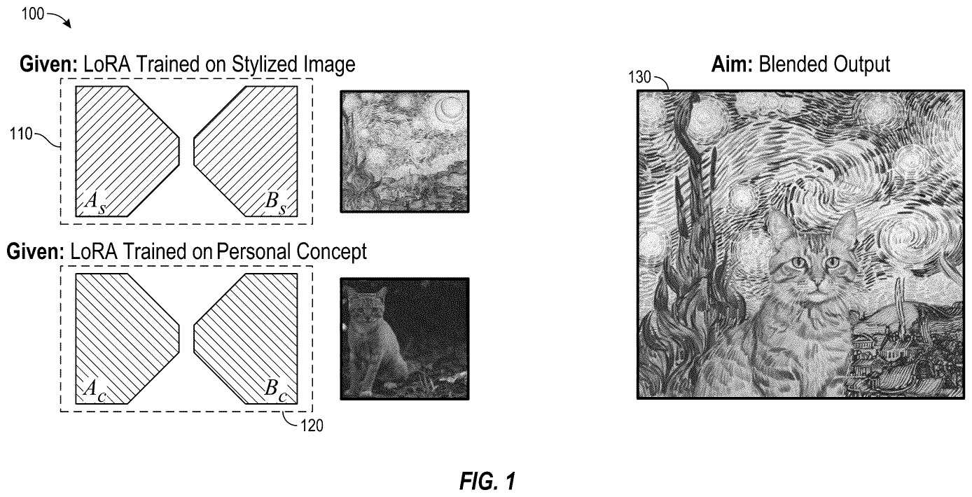

FIG. 1 depicts an example 100 of generating a blended (or merged) output using adapters (e.g., LoRA adapters) for a generative artificial intelligence model trained on different attributes of the blended output, according to certain aspects of the present disclosure.

As illustrated in the example 100, a generative artificial intelligence model may receive a request to generate an image output according to a concept (a.k.a. content) and a style to apply to the image. For example, the request may be, as illustrated in the example 100, a request to generate an image of a cat (the concept) in the style of a Vincent Van Gogh painting (the style). To do so, the input prompt, which may be tokenized prior to processing by a base generative artificial intelligence model (such as a diffusion neural network that can generate visual content via an iterative denoising process or other generative artificial intelligence model), and the tokenized input may be provided to a style adapter 110 and a concept adapter 120 for processing. Generally, these adapters may be trained to generate a value, such as a change in a learnable adapter weight matrix relative to a frozen base weight matrix associated with the base generative artificial intelligence model, that when combined with the base weight matrix, generates parameters that can be used by the generative artificial intelligence model to generate an output specific to the adapter (e.g., a stylized image output generated by the style adapter 110, an image output with an instance of an object generated by the concept adapter 120, etc.).

The output of the generative artificial intelligence model may be a blended output 130 that combines the style and content attributes identified in the request to generate the output of the generative artificial intelligence model and associated with the style adapter 110 and the concept adapter 120, respectively. As discussed, various techniques can be used to generate the blended output 130. For example, given the outputs ΔWₛ=Bₛ·Aₛ of the style adapter 110 and ΔW_{c}=B_{c}·A_{c} of the concept adapter 120, a merged adapter output that allows for the generation of the blended output 130 may be defined according to the expression:

$${∝}_{c} Δ {W}_{c} + {∝}_{s} Δ {W}_{s}$$

where ∂_{c} and ∂ₛ correspond to blending scalar values associated with the concept adapter 120 and the style adapter 110, respectively. However, merging the outputs of the style adapter 110 and the concept adapter 120 based on an additive process such as that described above may be computationally inefficient, as each adapter may perform computations on parameters that may not be relevant for the output of that adapter (e.g., may perform computations on local parameters even when the attribute associated with the adapter is a global attribute, may perform computations on global parameters even when the attribute associated with the adapter is a local attribute, or the like).

In some examples, a weighting vector m may be learned at the output dimension of each of the style adapter 110 and the concept adapter 120. These weighting vectors generally represent orthogonal masks that are learned such that the output of one adapter, such as the style adapter 110, is orthogonal (e.g., unrelated) to the output of another adapter, such as the concept adapter 120. The resulting merged adapter output that allows for the generation of the blended output 130 based on these orthogonal masks may be defined according to the expression:

$${m}_{c} Δ {W}_{c} + {m}_{s} Δ {W}_{s}$$

where m_{c} and mₛ correspond to the weighting vectors associated with the concept adapter 120 and the style adapter 110, respectively. However, as discussed above, because some attributes may be related instead of orthogonal, using orthogonal weighting vectors at the output stage of an adapter may also be computationally inefficient, as the adapter may perform redundant computations to generate outputs that end up being masked by the weighting vector associated with an adapter. Further, enforcing orthogonality of outputs associated with an adapter may cause a machine learning model to generate outputs that do not conform to the attributes defined in a request, as the orthogonal weighting vectors may not allow for the outputs of these adapters to be entangled even when the attributes associated with these adapters are related attributes and may significantly increase the number of learnable parameters associated with each adapter.

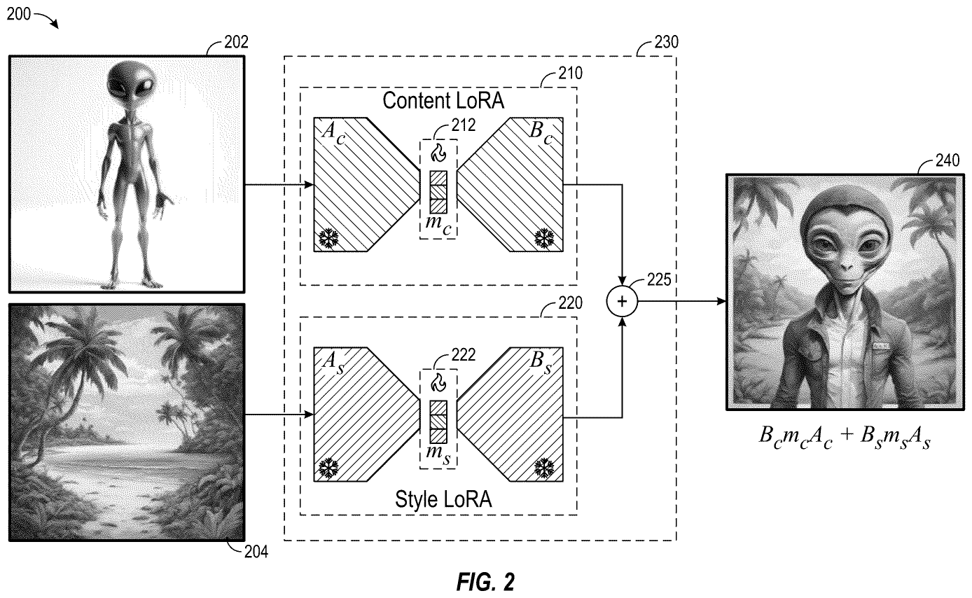

FIG. 2 illustrates a pipeline 200 for generating a blended output of different adapters trained on different attributes of the blended output, each adapter of the different adapters being associated with a mask in a low-rank dimension of the adapter, according to certain aspects of the present disclosure.

In the pipeline 200, a content adapter 210 and a style adapter 220 may be trained to generate images including specified content and content in a specified style, respectively. To allow for efficient merging of the content adapter 210 and style adapter 220 into a merged adapter 230 that to generates a blended output 240, the content adapter 210 and the style adapter 220 may be trained to generate masks 212, 222 in a low-rank dimension that efficiently enforce orthogonality of outputs associated with the content adapter 210 and the style adapter 220, respectively. As illustrated in FIG. 2, for example, the content adapter 210 may be trained to generate images including a variety of images, such as an alien according to the input image 202, and the style adapter 220 may be trained to generate images in a variety of styles, such as a tropical painting style according to the input image 204.

To train the content adapter 210 and the style adapter 220, training data sets I_{c} and Iₛ, respectively, may be used to train the content adapter 210 and the style adapter 220 to generate outputs according to content and style prompts, respectively. For example, the training data set I_{c} used to train the content adapter 210 may include a variety of images illustrating content that the adapter may be trained to generate, with each image being associated with a prompt p_{c}. A prompt p_{c}, for example, may be a natural language prompt that specifies the type of content illustrated in a corresponding image i_{c}∈I_{c}. Similarly, the training data set Iₛ used to train the style adapter 220 may include a variety of images in different styles that the adapter may be trained to apply to an output generated by a generative artificial intelligence model, with each image being associated with a prompt pₛ. A prompt pₛ, for example, may be a natural language prompt that specifies a style of image illustrated in a corresponding image iₛ∈Iₛ.

After the content adapter 210 and the style adapter 220 are initially trained, the weights associated with the content adapter 210 and the style adapter 220 may be frozen before the masks 212, 222 associated with the content adapter 210 and the style adapter 220, respectively, are trained in order to generate a merged adapter 230 via a combiner 225. The merged adapter 230, designated Lₘ in the equation below, may be trained on a loss function that itself is based on loss values calculated (1) between the merged adapter and the content adapter 210 (designated L_{c} in the equation below) and (2) between the merged adapter and the style adapter 220 (designated Lₛ in the equation below). For example, the loss L based on which the merged adapter 230 is trained may be represented by the equation:

$$L = ‖ ( D + {L}_{m} ) ( {I}_{c} , {p}_{c} ) - ( D - {L}_{c} ) ( {I}_{c} , {p}_{c} ) ‖ + ‖ ( D + {L}_{m} ) ( {I}_{s} , {p}_{s} ) - ( D - {L}_{s} ) ( {I}_{s} , {p}_{s} ) ‖ + λ {\sum }_{i}^{n} \vert {m}_{c}^{i} \cdot {m}_{s}^{i} \vert$$

In the equation above, D represents the base generative artificial intelligence model (e.g., a diffusion model that generates an output based on iterative denoising of an image starting from a Gaussian noise input) to which the content adapter 210, the style adapter 220, and the combiner 225 are applied, A is a defined scaling factor, and i corresponds to a specific layer of the generative artificial intelligence model. The masks 212, 222 (represented by m_{c} and mₛ, respectively) may be placed across the rank dimensions of the adapters 210, 220, respectively. Because the masks m_{c} 212 and mₛ 222 are placed across rank dimensions of their respective adapters 210 and 220, the masks may have fewer trainable parameters than masks associated with an output of the adapters 210 and 220 and further, as discussed in further detail below, may allow for rank to be adjusted to compensate for the locality of attributes associated with each adapter relative to the size of a receptive field of a specific layer of a generative artificial intelligence model.

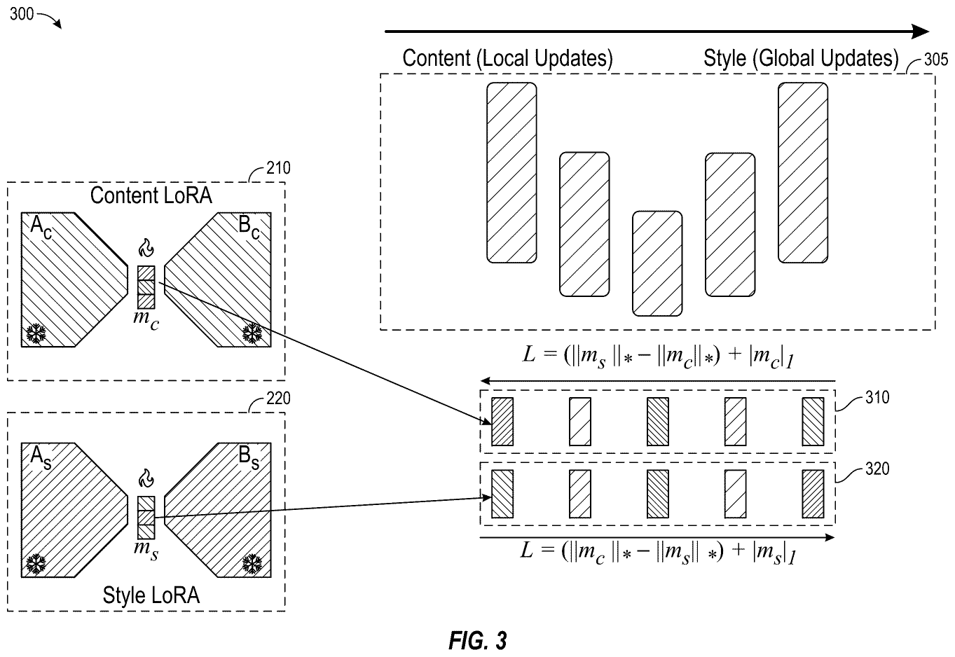

FIG. 3 illustrates rank constraints associated with layers of a generative artificial intelligence model 305 including adapters associated with different attributes of a blended output, according to certain aspects of the present disclosure.

In the generative artificial intelligence model 305, such as the diffusion model D discussed above with respect to FIG. 2, earlier layers in the generative artificial intelligence model may have low-resolution feature dimensions, and later layers in the generative artificial intelligence model may have progressively higher-resolution feature dimensions. Generally, the earlier layers in the generative artificial intelligence model 305 may thus be used to generate local portions of an output of the generative artificial intelligence model 305, such as instances of objects depicted in at specified (or random) locations of an image output of the generative artificial intelligence model. Later layers in the generative artificial intelligence model 305 may correspondingly be used to generate and/or modify content in larger portions of the output of the generative artificial intelligence model 305, such as generating style attributes applied to the image as a whole, or at least portions of an image including a variety of objects.

To enhance the training of adapters 210, 220 with masks m_{c} 310 and mₛ 320, respectively, by accounting for layer-specific information, the mask m_{c} 310 may be initialized based on a content threshold T_{content} and a style threshold T_{style} that ensures that the content rank exceeds the style rank in earlier layers of the generative artificial intelligence model. Similarly, the mask mₛ 320 may be initialized based on a content threshold T_{content} and a style threshold T_{style} that ensures that the content rank exceeds the style rank in later layers of the generative artificial intelligence model 305. Consequently, as illustrated in FIG. 3, the mask m_{c} 310 may have high weights in early layers of the generative artificial intelligence model and may be trained based on a layer prior loss represented according to the equation:

$$L = ( {‖ {m}_{s} ‖}_{*} - {‖ {m}_{c} ‖}_{*} ) + {\vert {m}_{c} \vert}_{1}$$

Conversely, the mask mₛ 320 may have high weights in later layers of the generative artificial intelligence model and may be trained based on a layer prior loss represented according to the equation:

$$L = ( {‖ {m}_{c} ‖}_{*} - {‖ {m}_{s} ‖}_{*} ) + {\vert {m}_{s} \vert}_{1}$$

In the equations representing the layer prior loss for the masks 310 and 320, m_{c} and mₛ represent content and style mergers.

The rank constraint enforced by the content threshold T_{content} and the style threshold T_{style} may allow for the rank assigned to content being higher than the rank assigned to style in some layers and for the rank assigned to style being higher than the rank assigned to content in other layers while merging the content adapter 210 and the style adapter 220 in the merged adapter 230 illustrated in FIG. 2. The output of the merged adapter 230 for a layer of the generative artificial intelligence model may be represented by the expression:

$${B}_{c} {m}_{c} {A}_{c} + {B}_{s} {m}_{s} {A}_{s}$$

where A_{c} and B_{c} represent the matrices associated with the content adapter 210 and Aₛ and Bₛ represent the matrices associated with the style adapter 220. Based on the rank constraint enforced on the content threshold T_{content} and the style threshold T_{style}, the output of the merged adapter 230 may be weighted towards content in layers of the generative artificial intelligence model that have low-resolution receptive fields and weighted towards style in layers of the generative artificial intelligence model that have higher-resolution receptive fields. In some aspects, the rank constraint may be defined as a rank minimization task, which may correspond to nuclear norm minimization that results in the calculation of the sum of singular values in the masks m_{c} 310 and mₛ 320, respectively.

During inferencing, the generative artificial intelligence model 305 including the merged adapter 230 generally receives as input a text prompt that specifies a type of object to be depicted in a particular style. The generative artificial intelligence model uses a tokenized version of the textual input to cause the merged adapter 230 to generate a plurality of variations of an output corresponding to the input text prompt and output the generated images. As discussed, because masking is performed in a low-rank dimension instead of on the output of the adapters, certain aspects of the present disclosure may allow for efficient generation of outputs using the merged adapter 230, as the masking in a low-rank dimensionality provided by the masks 310, 320 may reduce computation in higher-rank dimensionalities while allowing for different adapters associated with different attributes (e.g., content and style, amongst others not illustrated in FIGS. 2 and 3) to be weighted according to the impact of these adapters on a receptive field defined for each layer of the machine learning model.

In some aspects, ranks assigned to different attributes (e.g., content and style) defined for an output of a generative artificial intelligence model and associated with different adapters in the generative artificial intelligence model may bias the output of the generative artificial intelligence model. For example, in the content-style paradigm illustrated in FIGS. 2 and 3, assigning a high rank to content and a significantly smaller rank to style may result in the generative artificial intelligence model generating a content-biased output that may not reflect the requested style to be applied to the content. To allow for a generative artificial intelligence model to reduce disentanglement between different attributes, certain aspects of the present disclosure may use a cycle-consistency loss to train a merged adapter to generate an output that reflects multiple attributes defined in an input prompt. Generally, a cycle may include a forward and backward transformation of a sample (e.g., an image), such as the application and removal of an attribute from a base sample of content. Generally, a cycle-consistency loss may be used to minimize, or at least reduce, a loss associated between a ground-truth input and a reconstructed version of the input after applying and removing an attribute to the ground-truth input.

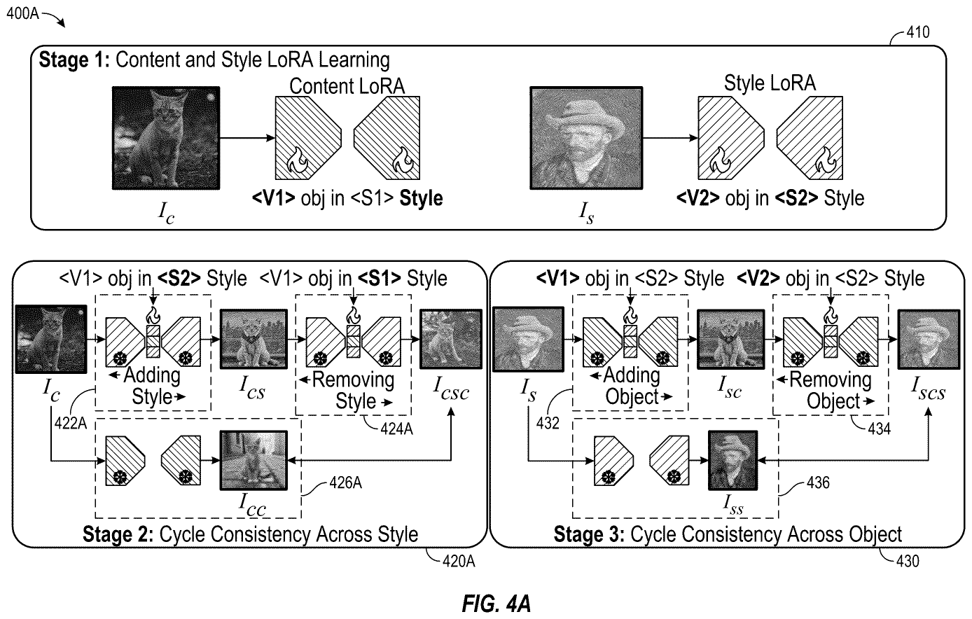

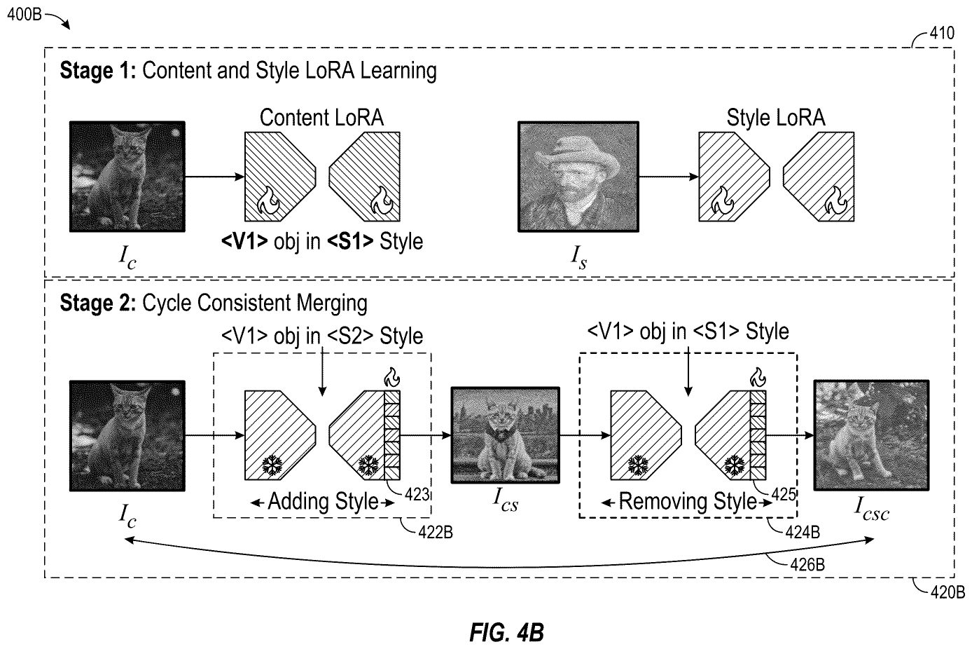

FIGS. 4A and 4B illustrate pipelines 400A, 400B for training a generative artificial intelligence model based on a cycle-consistency loss to generate a blended output using adapters associated with different attributes of the blended output, according to certain aspects of the present disclosure.

In both the pipelines 400A and 400B, the generative artificial intelligence model may be trained by training attribute-specific adapters (e.g., a content adapter and a style adapter) at block 410, for example, as discussed above with respect to the training of the content adapter 210 and the style adapter 220 illustrated in FIG. 2. The training of the attribute-specific adapters may be based on training data sets (e.g., a content image data set I_{c} and a style image data set Iₛ, each of which may be associated with prompts describing the images in I_{c} and Iₛ, respectively).

As illustrated in block 420A and 420B, the style adapter may be trained based on a cycle-consistency loss. To do so, a content image I_{c} and a corresponding prompt p_{c} (e.g., in the format of “A<V1> object in <S2> style”) may be input into the style adapter at block 422A or 422B to produce a style-injected content image I_{CS}. Subsequently, at block 424A or 424B, style may be removed from the image by inputting the style-injected content image I_{CS} and a prompt to effectively remove the injected style (e.g., “A<V1> object in <S1> style”) into the style adapter at block 424A or 424B. The resulting image, designated I_{CSC}, may be compared to other images generated by the content adapter including a depiction of the specified object, designated I_{CC}, thus generating a cycle-consistency loss according to the expression:

$${L}_{cycle \_ style} = MSE ( {I}_{CC} , {I}_{CSC} )$$

While the above equation illustrates the use of mean squared error (MSE) to define a difference between I_{CC} and I_{CSC}, it should be recognized that any appropriate difference or distance function may be used to define L_{cycle_style}. At block 426A or 426B, the style adapter may be trained by minimizing, or at least reducing, the style cycle loss represented by L_{cycle_style}. Minimizing, or at least reducing, the style cycle loss by adding and removing style through a text prompt may thus allow for a style adapter to be trained to add style to content while allowing for the object to be reconstructable.

Similarly, at block 430, the content adapter may be trained based on a cycle-consistency loss. To do so, a style image Iₛ and a corresponding prompt pₛ (e.g., in the format of “A<V1> object in <S2> style”) may be input into the content adapter at block 432 to produce a content-injected style image I_{SC}. Subsequently, at block 434, the content may be removed from the content-injected style image by inputting the content-injected style image I_{SC} and a prompt to effectively remove the injected style (e.g., “A<V1> object in <S1> style”) into the content adapter at block 434. The resulting image, designated I_{SCS}, may be compared to other images generated by the style adapter including a depiction of objects in the specified style, designated I_{SS}, thus generating a cycle-consistency loss according to the expression:

$${L}_{cycle \_ object} = MSE ( {I}_{SS} , {I}_{SCS} )$$

While the above equation illustrates the use of mean squared error to define a difference between I_{SS} and I_{SCS}, it should be recognized that any appropriate difference or distance function may be used to define L_{cycle_object}. At block 436, the style adapter may be trained by minimizing, or at least reducing, the style cycle loss represented by L_{cycle_object}, Minimizing, or at least reducing, the style cycle loss by adding and removing style through a text prompt may thus allow for a style adapter to be trained to add style to content while allowing for the object to be reconstructable.

The merged adapter may be trained using the content adapter and the style adapter and a cycle-consistency losses defined according to the equation:

$${L}_{cycle} = ‖ ( D + {L}_{m} ) ( {I}_{c} , {p}_{c} ) - ( D - {L}_{c} ) ( {I}_{c} , {p}_{c} ) ‖ + ‖ ( D + {L}_{m} ) ( {I}_{s} , {p}_{s} ) - ( D - {L}_{s} ) ( {I}_{s} , {p}_{s} ) ‖ + λ \cdot {L}_{cycle \_ style} + λ \cdot {L}_{cycle \_ object}$$

where Lₘ corresponds to the merged adapter, L_{c} corresponds to the content adapter, Lₛ corresponds to the style adapter, D represents the base generative artificial intelligence model (e.g., a diffusion model that generates an output based on iterative denoising of an image starting from a Gaussian noise input) to which the content adapter, the style adapter, and the merged adapter are applied, and A is a defined scaling factor.

In the example 400A, in which low-rank dimension masks and a layer prior are also used to train the adapters (e.g., as discussed above with respect to FIGS. 2 and 3), the overall loss used during merging may become L=L_{layer_prior}+L_{cycle}. In the example 400B, cycle-consistency loss may be used to train adapters that include learned masks 423 and 425 at the output of these adapters that allow the adapters to generate orthogonal outputs.

### Example Operations for Training and Using Generative Artificial Intelligence Models to Generate Outputs Based on Merging Attribute-Specific Adapters

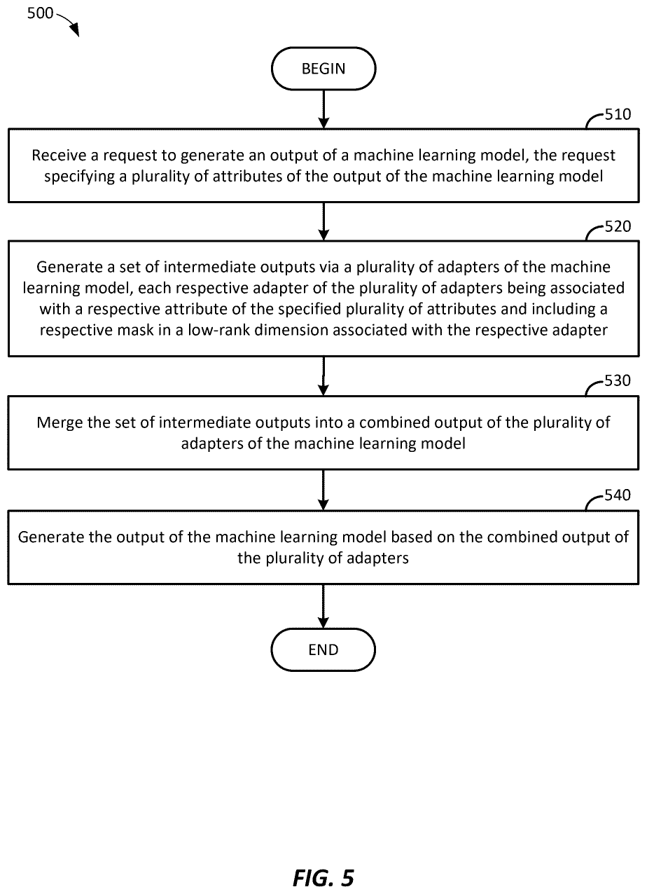

FIG. 5 illustrates example operations 500 for generating an output of a generative artificial intelligence model based on defined attributes and adapters associated with the defined attributes, according to certain aspects of the present disclosure (e.g., using a model illustrated in FIGS. 2, 3, 4A, and/or 4B). The operations 500 may be performed by a device on which a generative artificial intelligence model can be deployed, such as a smartphone, a tablet computer, a laptop computer, a desktop, a server, a cloud compute instance hosted in a distributed computing environment, or the like.

As illustrated, the operations 500 begin at block 510 with receiving a request to generate an output of a machine learning model. Generally, the request specifies a plurality of attributes of the output of the machine learning model.

At block 520, the operations 500 proceed with generating a set of intermediate outputs via a plurality of adapters of the machine learning model. Generally, each respective adapter of the plurality of adapters may be associated with a respective attribute of the specified plurality of attributes and may include a respective mask in a low-rank dimension associated with the respective adapter.

At block 530, the operations 500 proceed with merging the set of intermediate outputs into a combined output of the plurality of adapters of the machine learning model.

At block 540, the operations 500 proceed with generating the output of the machine learning model based on the combined output of the plurality of adapters.

In some aspects, the output of the machine learning model is an image output. The plurality of attributes may include an object to be depicted in the image output generated by the machine learning model and a style of the image output generated by the machine learning model.

In some aspects, the machine learning model comprises a model trained based on a content loss, a style loss, and a scaling factor associated with a similarity term.

In some aspects, the respective mask associated with the respective adapter comprises a weighting vector with learnable weight values in the low-rank dimension. In this case, a masked output associated with a first adapter of the plurality of adapters may be orthogonal to a masked output associated with a second adapter of the plurality of adapters.

In some aspects, the set of intermediate outputs comprises a plurality of images. Each image of the plurality of images corresponds to an image conforming to an attribute from the specified plurality of attributes.

In some aspects, a first adapter of the plurality of adapters is biased to operating on earlier layers over later layers in the machine learning model and a second adapter of the plurality of adapters is biased to operating on later layers over earlier layers of the machine learning model.

In some aspects, each respective mask is based on a loss based on a rank constraint and sparsity constraint. For example, as discussed above, the rank constraint may be defined such that masks associated with adapters in layers of a generative artificial model with lower-resolution receptive fields are weighted towards content or other attributes that have a localized impact on the resulting output of the generative artificial intelligence model, Similarly, masks associated with adapters in layers of the generative artificial intelligence model with higher-resolution receptive fields may be weighted towards style or other attributes that have a more global impact on the resulting output of the generative artificial intelligence model. The sparsity constraint may be defined based on the masks associated with the different adapters (e.g., |m_{c}|₁ and |mₛ|₁ for content and style adapters, respectively).

In some aspects, a rank associated with a first attribute of the specified plurality of attributes exceeds a rank associated with a second attribute of the specified plurality of attributes in a first plurality of layers of the machine learning model. In this case, a rank associated with the second attribute of the specified plurality of attributes may exceed a rank associated with the first attribute of the specified plurality of attributes in a second plurality of layers of the machine learning model. The second plurality of layers may be layers subsequent to the first plurality of layers.

In some aspects, the plurality of adapters of the machine learning model includes adapters configured based on a cycle-consistency loss between a first attribute of the plurality of attributes and a second attribute of the plurality of attributes. A cycle associated with the cycle-consistency loss may include an application and a removal of an attribute from the specified plurality of attributes to data complying with another attribute from the specified plurality of attributes.

In some aspects, at least one of the adapters has frozen weights and an output mask with learnable weights associated with the cycle-consistency loss.

In some aspects, at least one of the adapters has learnable weights associated with the cycle-consistency loss in the low-rank dimension of the at least one of the adapters.

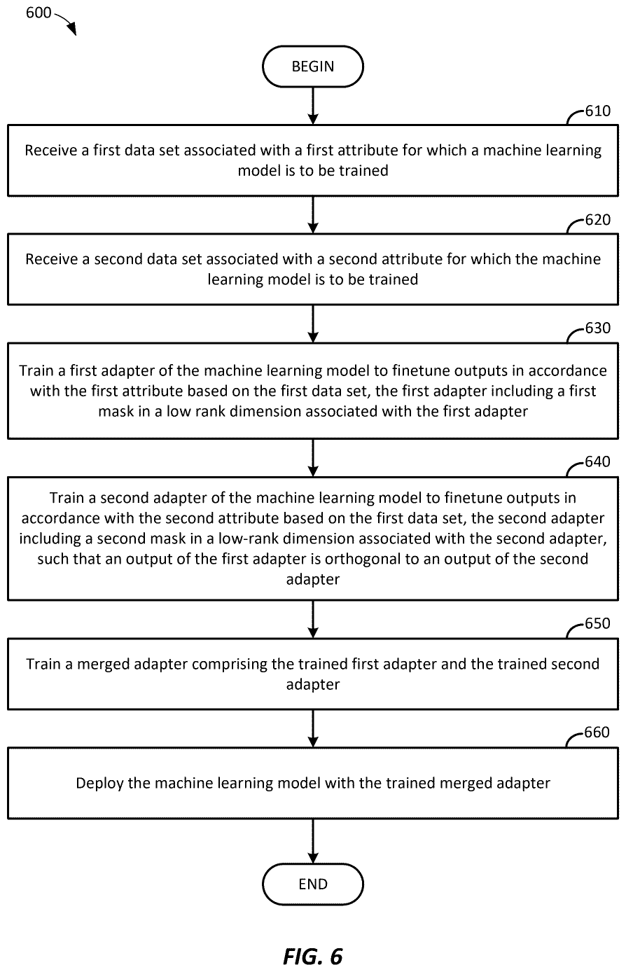

FIG. 6 illustrates example operations 600 for training a generative artificial intelligence model (e.g., the models illustrated in FIGS. 2, 3, 4A, and/or 4B) to generate a blended output based on defined attributes and adapters associated with the defined attributes, according to certain aspects of the present disclosure. The operations 600 may be performed by a device on which a generative artificial intelligence model can be trained, such as a smartphone, a tablet computer, a laptop computer, a desktop, a server, a cloud compute instance hosted in a distributed computing environment, or the like. In some aspects, the operations 600 may be performed on the same device as a device on which the operations 500 execute.

As illustrated, the operations 600 begin at block 610, with receiving a first data set associated with a first attribute for which a machine learning model is to be trained.

At block 620, the operations 600 proceed with receiving a second data set associated with a second attribute for which the machine learning model is to be trained.

At block 630, the operations 600 proceed with training a first adapter of the machine learning model to finetune outputs in accordance with the first attribute based on the first data set. Generally, the first adapter includes a first mask in a low-rank dimension associated with the first adapter.

At block 640, the operations 600 proceed with training a second adapter of the machine learning model to finetune outputs in accordance with the second attribute based on the second data set. Generally, the second adapter includes a second mask in a low-rank dimension associated with the second adapter, such that an output of the first adapter is orthogonal to an output of the second adapter.

At block 650, the operations 600 proceed with training a merged adapter comprising the trained first adapter and the trained second adapter.

At block 660, the operations 600 proceed with deploying the machine learning model with the trained merged adapter.

In some aspects, the machine learning model is configured to generate an image output. The plurality of attributes may include an object to be depicted in the image output generated by the machine learning model and a style of the image output generated by the machine learning model.

In some aspects, the merged adapter is trained based on a loss associated with the first adapter, a loss associated with the second adapter, and a scaling factor associated with a similarity term. The scaling factor may be applied, in some aspects, to a combination of the first mask and the second mask.

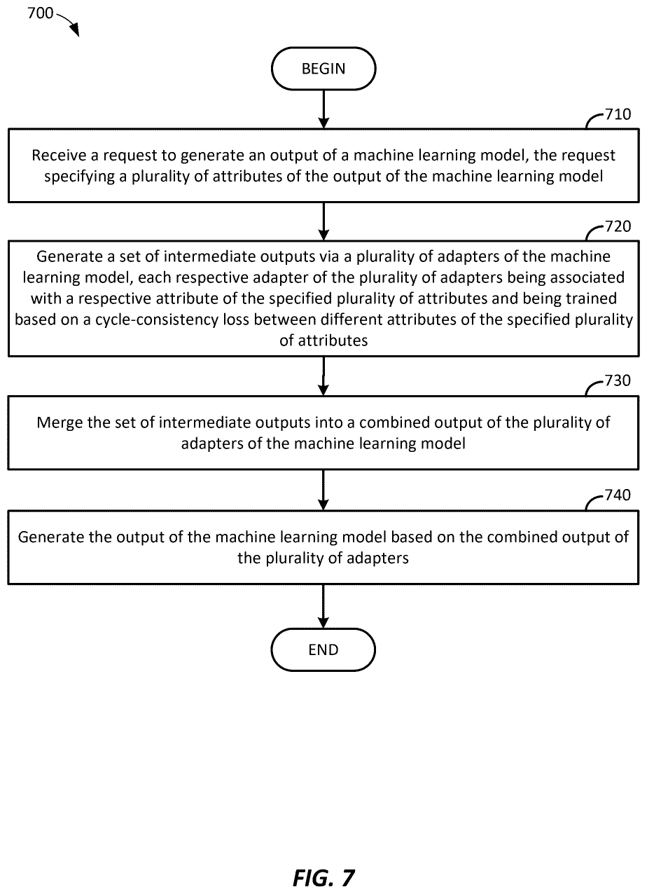

FIG. 7 illustrates example operations 700 for generating an output of a generative artificial intelligence model (e.g., a model such as that illustrated in FIGS. 4A and/or 4B) based on defined attributes and adapters associated with the defined attributes, according to certain aspects of the present disclosure. The operations 700 may be performed by a device on which a generative artificial intelligence model can be deployed, such as a smartphone, a tablet computer, a laptop computer, a desktop, a server, a cloud compute instance hosted in a distributed computing environment, or the like.

As illustrated, the operations 700 begin at block 710 with receiving a request to generate an output of a machine learning model. Generally, the request specifies a plurality of attributes for the output of the machine learning model.

At block 720, the operations 700 proceed with generating a set of intermediate outputs via a plurality of adapters of the machine learning model. Generally, each respective adapter of the plurality of adapters is associated with a respective attribute of the specified plurality of attributes and is trained based on a cycle-consistency loss between different attributes of the specified plurality of attributes.

At block 730, the operations 700 proceed with merging the set of intermediate outputs into a combined output of the plurality of adapters of the machine learning model.

At block 740, the operations 700 proceed with generating the output of the machine learning model based on the combined output of the plurality of adapters.

In some aspects, the output of the machine learning model is an image output. In this case, the plurality of attributes may include an object to be depicted in the image output generated by the machine learning model and a style of the image output generated by the machine learning model.

In some aspects, the machine learning model comprises a model trained further based on a content loss and a style loss. The cycle-consistency loss may include a first cycle-consistency loss for a first forward and backward transformation of content with different styles and a second cycle-consistency loss for a second forward and backward transformation of style with different contents.

In some aspects, the cycle-consistency loss is weighted based on a defined scaling factor.

In some aspects, the set of intermediate outputs comprises a plurality of images, each image of the plurality of images corresponding to an image conforming to an attribute from the specified plurality of attributes.

In some aspects, a first adapter of the plurality of adapters is biased to operating on earlier layers in the machine learning model over a second adapter of the plurality of adapters, and the second adapter is biased to operating on later layers in the machine learning model over the first adapter.

In some aspects, at least one of the adapters has frozen weights and an output mask with learnable weights associated with the cycle-consistency loss.

In some aspects, at least one of the adapters has learnable weights associated with the cycle-consistency loss in a rank dimension of the at least one of the adapters.

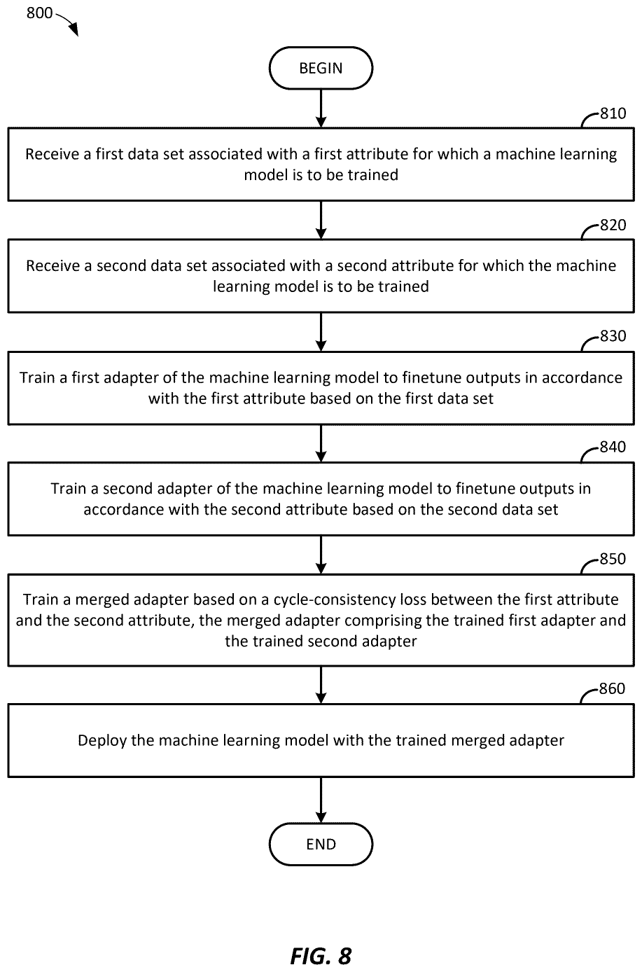

FIG. 8 illustrates example operations 800 for training a generative artificial intelligence model (e.g., a model illustrated in FIGS. 4A and/or 4B) to generate a blended output based on defined attributes and adapters associated with the defined attributes, according to certain aspects of the present disclosure. The operations 800 may be performed by a device on which a generative artificial intelligence model can be trained, such as a smartphone, a tablet computer, a laptop computer, a desktop, a server, a cloud compute instance hosted in a distributed computing environment, or the like. In some aspects, the operations 800 may be performed on the same device as a device on which the operations 700 execute.

As illustrated, the operations 800 begin at block 810, with receiving a first data set associated with a first attribute for which a machine learning model is to be trained.

At block 820, the operations 800 proceed with receiving a second data set associated with a second attribute for which the machine learning model is to be trained.

At block 830, the operations 800 proceed with training a first adapter of the machine learning model to finetune outputs in accordance with the first attribute based on the first data set.

At block 840, the operations 800 proceed with training a second adapter of the machine learning model to finetune outputs in accordance with the second attribute based on the second data set.

At block 850, the operations 800 proceed with training a merged adapter based on a cycle-consistency loss between the first attribute and the second attribute, the merged adapter comprising the first adapter and the second adapter.

At block 860, the operations 800 proceed with deploying the machine learning model with the trained merged adapter.

In some aspects, the first attribute comprises an object to be depicted in an image output generated by the machine learning model. In this case, the second attribute may include a style for the image output generated by the machine learning model.

In some aspects, the cycle-consistency loss comprises a first cycle-consistency loss for a first forward and backward transformation of content with different styles and a second cycle-consistency loss for a second forward and backward transformation of style with different contents. In some aspects, calculating the first cycle-consistency loss comprises accessing a sample including the content with a first style, applying a second style to the sample using the second adapter to generate a style-injected content sample, reconstructing the sample by applying the first style to the style-injected content sample to remove the second style, using the second adapter, and calculating the first cycle-consistency loss based on a difference between the sample and the reconstructed sample. In some aspects, calculating the second cycle-consistency loss comprises accessing a sample including a first content according to the style, changing the first content in the sample to a second content using the first adapter to generate a content-injected style sample, reconstructing the sample by changing the second content in the content-injected style sample to the first content, using the first adapter, and calculating the second cycle-consistency loss based on a difference between the sample and the reconstructed sample.

In some aspects, at least one of the first adapter or the second adapter has frozen weights and an output mask with learnable weights associated with the cycle-consistency loss.

In some aspects, at least one of the first adapter or the second adapter has learnable weights associated with the cycle-consistency loss in a rank dimension of the at least one of the first adapter or the second adapter.

### Example Processing Systems for Training and Using Generative Artificial Intelligence Models to Generate Outputs Based on Merging Attribute-Specific Adapters

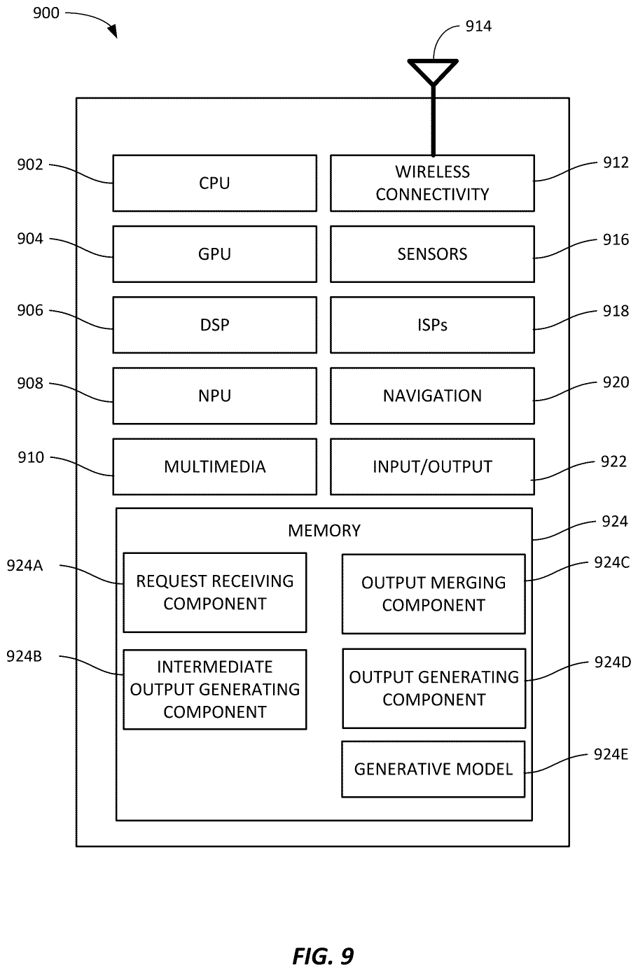

FIG. 9 depicts an example processing system 900 for using a generative artificial intelligence model to generate an output based on merging attribute-specific adapters, such as described herein for example with respect to FIGS. 5 and/or 7.

The processing system 900 includes a central processing unit (CPU) 902, which in some examples may be a multi-core CPU. Instructions executed at the CPU 902 may be loaded, for example, from a program memory associated with the CPU 902 or may be loaded from a memory partition (e.g., of a memory 924).

The processing system 900 also includes additional processing components tailored to specific functions, such as a graphics processing unit (GPU) 904, a digital signal processor (DSP) 906, a neural processing unit (NPU) 908, and a connectivity component 912.

An NPU, such as the NPU 908, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 908, are configured to accelerate the performance of common machine learning tasks, such as image classification, machine translation, object detection, and various other predictive models. In some examples, a plurality of NPUs may be instantiated on a single chip, such as a system on a chip (SoC), while in other examples such NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this new piece through an already trained model to generate a model output (e.g., an inference).

In some implementations, the NPU 908 is a part of one or more of the CPU 902, the GPU 904, and/or the DSP 906. These may be located on a user equipment (UE) in a wireless communication system or another computing device.

In some examples, the connectivity component 912 may include subcomponents, for example, for third generation (3G) connectivity, fourth generation (4G) connectivity (e.g., Long-Term Evolution (LTE)), fifth generation (5G) connectivity (e.g., New Radio (NR)), Wi-Fi connectivity, Bluetooth connectivity, and other wireless data transmission standards. The connectivity component 912 may be further coupled to one or more antennas 914.

The processing system 900 may also include one or more sensor processing units 916 associated with any manner of sensor, one or more image signal processors (ISPs) 918 associated with any manner of image sensor, and/or a navigation processor 920, which may include satellite-based positioning system components (e.g., GPS or GLONASS) as well as inertial positioning system components.

The processing system 900 may also include one or more input and/or output devices 922, such as screens, touch-sensitive surfaces (including touch-sensitive displays), physical buttons, speakers, microphones, and the like.

In some examples, one or more of the processors of the processing system 900 may be based on an ARM or RISC-V instruction set.

The processing system 900 also includes the memory 924, which is representative of one or more static and/or dynamic memories, such as a dynamic random access memory, a flash-based static memory, and the like. In this example, the memory 924 includes computer-executable components, which may be executed by one or more of the aforementioned processors of the processing system 900.

In particular, in this example, the memory 924 includes a request receiving component 924A, an intermediate output generating component 924B, an output merging component 924C, an output generating component 924D, and a generative model 924E. The depicted components, and others not depicted, may be configured to perform various aspects of the methods described herein.

Generally, the processing system 900 and/or components thereof may be configured to perform the methods described herein.

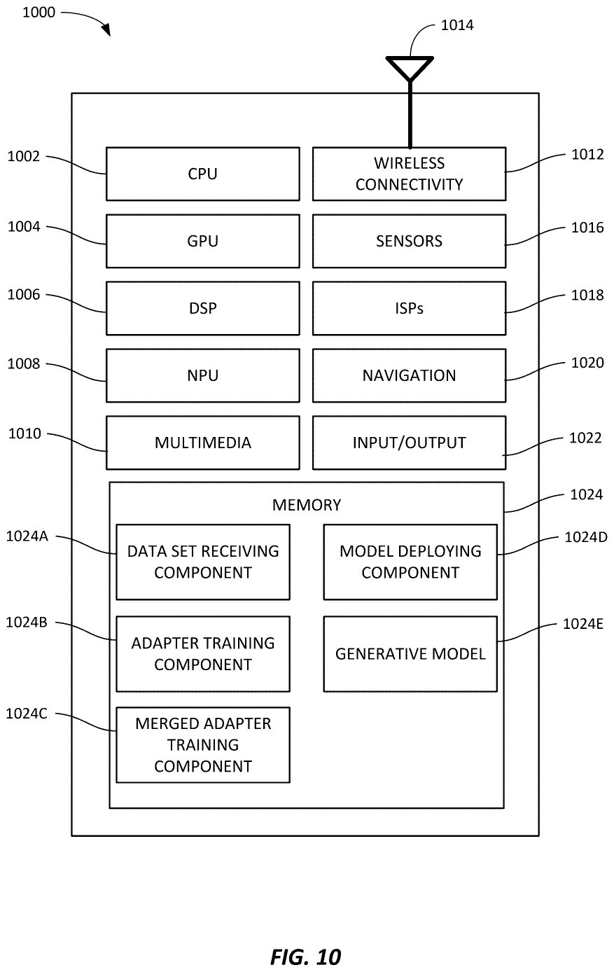

FIG. 10 depicts an example processing system 1000 for training a generative artificial intelligence model to generate an output based on merged attribute-specific adapters, such as described herein for example with respect to FIGS. 6 and/or 8.

The processing system 1000 includes a central processing unit (CPU) 1002, which in some examples may be a multi-core CPU. Instructions executed at the CPU 1002 may be loaded, for example, from a program memory associated with the CPU 1002 or may be loaded from a memory partition (e.g., of a memory 1024).

The processing system 1000 also includes additional processing components tailored to specific functions, such as a graphics processing unit (GPU) 1004, a digital signal processor (DSP) 1006, a neural processing unit (NPU) 1008, and a connectivity component 1012.

In some examples, the connectivity component 1012 may include subcomponents, for example, for third generation (3G) connectivity, fourth generation (4G) connectivity (e.g., Long-Term Evolution (LTE)), fifth generation (5G) connectivity (e.g., New Radio (NR)), Wi-Fi connectivity, Bluetooth connectivity, and other wireless data transmission standards. The connectivity component 1012 may be further coupled to one or more antennas 1014.

The processing system 1000 may also include one or more sensor processing units 1016 associated with any manner of sensor, one or more image signal processors (ISPs) 1018 associated with any manner of image sensor, and/or a navigation processor 1020, which may include satellite-based positioning system components (e.g., GPS or GLONASS) as well as inertial positioning system components.

The processing system 1000 may also include one or more input and/or output devices 1022, such as screens, touch-sensitive surfaces (including touch-sensitive displays), physical buttons, speakers, microphones, and the like.

In some examples, one or more of the processors of the processing system 1000 may be based on an ARM or RISC-V instruction set.

The processing system 1000 also includes the memory 1024, which is representative of one or more static and/or dynamic memories, such as a dynamic random access memory, a flash-based static memory, and the like. In this example, the memory 1024 includes computer-executable components, which may be executed by one or more of the aforementioned processors of the processing system 1000.

In particular, in this example, the memory 1024 includes a data set receiving component 1024A, an adapter training component 1024B, a merged adapter training component 1024C, a model deploying component 1024D, and a generative model 1024E. The depicted components, and others not depicted, may be configured to perform various aspects of the methods described herein.

Generally, the processing system 1000 and/or components thereof may be configured to perform the methods described herein.

### Example Clauses

Implementation details of various aspects of the present disclosure are described in the following numbered clauses.

Clause 1: A processor-implemented method for machine learning, comprising: receiving a request to generate an output of a machine learning model, the request specifying a plurality of attributes of the output of the machine learning model; generating a set of intermediate outputs via a plurality of adapters of the machine learning model, each respective adapter of the plurality of adapters being associated with a respective attribute of the specified plurality of attributes and including a respective mask in a low-rank dimension associated with the respective adapter; merging the set of intermediate outputs into a combined output of the plurality of adapters of the machine learning model; and generating the output of the machine learning model based on the combined output of the plurality of adapters.

Clause 2: The method of Clause 1, wherein the output of the machine learning model is an image output and wherein the plurality of attributes includes: an object to be depicted in the image output generated by the machine learning model; and a style of the image output generated by the machine learning model.

Clause 3: The method of Clause 1 or 2, wherein the machine learning model comprises a model trained based on one or more of a content loss, a style loss, or a scaling factor associated with a similarity term.

Clause 4: The method of any of Clauses 1 through 3, wherein the respective mask associated with the respective adapter comprises a weighting vector with learnable weight values in the low-rank dimension and wherein a masked output associated with a first adapter of the plurality of adapters is orthogonal to a masked output associated with a second adapter of the plurality of adapters.

Clause 5: The method of any of Clauses 1 through 4, wherein the set of intermediate outputs comprises a plurality of images, each image of the plurality of images corresponding to an image conforming to an attribute from the specified plurality of attributes.

Clause 6: The method of any of Clauses 1 through 5, wherein a first adapter of the plurality of adapters is biased to operating on earlier layers over later layers in the machine learning model and a second adapter of the plurality of adapters is biased to operating on later layers over earlier layers of the machine learning model.

Clause 7: The method of any of Clauses 1 through 6, wherein each respective mask is based on a loss based on a rank constraint and a sparsity constraint.

Clause 8: The method of any of Clauses 1 through 7, wherein: a rank associated with a first attribute of the specified plurality of attributes exceeds a rank associated with a second attribute of the specified plurality of attributes in a first plurality of layers of the machine learning model; and a rank associated with the second attribute of the specified plurality of attributes exceeds a rank associated with the first attribute of the specified plurality of attributes in a second plurality of layers of the machine learning model, the second plurality of layers being layers subsequent to the first plurality of layers.

Clause 9: The method of any of Clauses 1 through 8, wherein: the plurality of adapters of the machine learning model comprise adapters configured based on a cycle-consistency loss between a first attribute of the plurality of attributes and a second attribute of the plurality of attributes; and a cycle associated with the cycle-consistency loss comprises an application and a removal of an attribute from the specified plurality of attributes to data complying with another attribute from the specified plurality of attributes.

Clause 10: The method of Clause 9, wherein at least one of the adapters has frozen weights and an output mask with learnable weights associated with the cycle-consistency loss.

Clause 11: The method of Clause 9 or 10, wherein at least one of the adapters has learnable weights associated with the cycle-consistency loss in the low-rank dimension of the at least one of the adapters.

Clause 12: A processor-implemented method for machine learning, comprising: receiving a first data set associated with a first attribute for which a machine learning model is to be trained; receiving a second data set associated with a second attribute for which the machine learning model is to be trained; training a first adapter of the machine learning model to finetune outputs in accordance with the first attribute based on the first data set, the first adapter including a first mask in a low-rank dimension associated with the first adapter; training a second adapter of the machine learning model to finetune outputs in accordance with the second attribute based on the second data set, the second adapter including a second mask in a low-rank dimension associated with the second adapter, such that an output of the first adapter is orthogonal to an output of the second adapter; training a merged adapter comprising the trained first adapter and the trained second adapter; and deploying the machine learning model with the trained merged adapter.

Clause 13: The method of Clause 12, wherein the machine learning model and is configured to generate an image output and wherein the plurality of attributes includes: an object to be depicted in the image output generated by the machine learning model; and a style of the image output generated by the machine learning model.

Clause 14: The method of Clause 12 or 13, wherein the merged adapter is trained based on a loss associated with the first adapter, a loss associated with the second adapter, and a scaling factor associated with a similarity term.

Clause 15: The method of Clause 14, wherein the scaling factor is applied to a combination of the first mask and the second mask.

Clause 16: A processor-implemented method for machine learning, comprising: receiving a request to generate an output of a machine learning model, the request specifying a plurality of attributes for the output of the machine learning model; generating a set of intermediate outputs via a plurality of adapters of the machine learning model, each respective adapter of the plurality of adapters being associated with a respective attribute of the specified plurality of attributes and being trained based on a cycle-consistency loss between different attributes of the specified plurality of attributes; merging the set of intermediate outputs into a combined output of the plurality of adapters of the machine learning model; and generating the output of the machine learning model based on the combined output of the plurality of adapters.

Clause 17: The method of Clause 16, wherein the output of the machine learning model is an image output and wherein the plurality of attributes includes: an object to be depicted in the image output generated by the machine learning model; and a style of the image output generated by the machine learning model.

Clause 18: The method of Clause 16 or 17, wherein the machine learning model comprises a model trained further based on one or more of a content loss or a style loss and wherein the cycle-consistency loss comprises a first cycle-consistency loss for a first forward and backward transformation of content with different styles and a second cycle-consistency loss for a second forward and backward transformation of style with different contents.

Clause 19: The method of any of Clauses 16 through 18, wherein the cycle-consistency loss is weighted based on a defined scaling factor.

Clause 20: The method of any of Clauses 16 through 19, wherein the set of intermediate outputs comprises a plurality of images, each image of the plurality of images corresponding to an image conforming to an attribute from the specified plurality of attributes.

Clause 21: The method of any of Clauses 16 through 20, wherein a first adapter of the plurality of adapters is biased to operating on earlier layers in the machine learning model over a second adapter of the plurality of adapters and wherein the second adapter is biased to operating on later layers in the machine learning model over the first adapter.

Clause 22: The method of any of Clauses 16 through 21, wherein at least one of the adapters has frozen weights and an output mask with learnable weights associated with the cycle-consistency loss.

Clause 23: The method of any of Clauses 16 through 22, wherein at least one of the adapters has learnable weights associated with the cycle-consistency loss in a rank dimension of the at least one of the adapters.

Clause 24: A processor-implemented method for machine learning, comprising: receiving a first data set associated with a first attribute of an output for which a machine learning model is to be trained; receiving a second data set associated with a second attribute of the output for which the machine learning model is to be trained; training a first adapter of the machine learning model to finetune outputs in accordance with the first attribute based on the first data set; training a second adapter of the machine learning model to finetune outputs in accordance with the second attribute based on the second data set; training a merged adapter based on a cycle-consistency loss between the first attribute and the second attribute, the merged adapter comprising the first adapter and the second adapter; and deploying the machine learning model with the trained merged adapter.

Clause 25: The method of Clause 24, wherein the first attribute comprises an object to be depicted in an image output generated by the machine learning model and wherein the second attribute comprises a style for the image output generated by the machine learning model.

Clause 26: The method of Clause 24 or 25, wherein the cycle-consistency loss comprises a first cycle-consistency loss for a first forward and backward transformation of content with different styles and a second cycle-consistency loss for a second forward and backward transformation of style with different contents.

Clause 27: The method of Clause 26, wherein calculating the first cycle-consistency loss comprises: accessing a sample including the content with a first style; applying a second style to the sample using the second adapter to generate a style-injected content sample; reconstructing the sample by applying the first style to the style-injected content sample to remove the second style, using the second adapter; and calculating the first cycle-consistency loss based on a difference between the sample and the reconstructed sample.

Clause 28: The method of Clause 26 or 27, wherein calculating the second cycle-consistency loss comprises: accessing a sample including a first content according to the style; changing the first content in the sample to a second content using the first adapter to generate a content-injected style sample; reconstructing the sample by changing the second content in the content-injected style sample to the first content, using the first adapter; and calculating the second cycle-consistency loss based on a difference between the sample and the reconstructed sample.

Clause 29: The method of any of Clauses 24 through 28, wherein at least one of the first adapter or the second adapter has frozen weights and an output mask with learnable weights associated with the cycle-consistency loss.

Clause 30: The method of any of Clauses 24 through 29, wherein at least one of the first adapter or the second adapter has learnable weights associated with the cycle-consistency loss in a rank dimension of the at least one of the first adapter or the second adapter.

Clause 31: A processing system, comprising: at least one memory having executable instructions stored thereon; and one or more processors configured to execute the executable instructions in order to cause the processing system to perform the operations of any of Clauses 1 through 30.

Clause 32: A processing system, comprising: means for performing the operations of any of Clauses 1 through 30.

Clause 33: A non-transitory computer-readable medium having executable instructions stored thereon which, when executed by one or more processors, performs the operations of any of Clauses 1 through 30.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system for machine learning, comprising:
at least one memory having executable instructions stored thereon; and
one or more processors configured to execute the executable instructions in order to cause the processing system to:
receive a request to generate an output of a machine learning model, the request specifying a plurality of attributes for the output of the machine learning model;
generate a set of intermediate outputs via a plurality of adapters of the machine learning model, each respective adapter of the plurality of adapters being associated with a respective attribute of the specified plurality of attributes and being trained based on a cycle-consistency loss between different attributes of the specified plurality of attributes;
merge the set of intermediate outputs into a combined output of the plurality of adapters of the machine learning model; and
generate the output of the machine learning model based on the combined output of the plurality of adapters.

2. The processing system of claim 1, wherein the output of the machine learning model is an image output and wherein the plurality of attributes includes:
an object to be depicted in the image output generated by the machine learning model; and
a style of the image output generated by the machine learning model.

3. The processing system of claim 1, wherein the machine learning model comprises a model trained further based on one or more of a content loss or a style loss, and wherein the cycle-consistency loss comprises a first cycle-consistency loss for a first forward and backward transformation of content with different styles and a second cycle-consistency loss for a second forward and backward transformation of style with different contents.

4. The processing system of claim 1, wherein the cycle-consistency loss is weighted based on a defined scaling factor.

5. The processing system of claim 1, wherein the set of intermediate outputs comprises a plurality of images, each image of the plurality of images corresponding to an image conforming to an attribute from the specified plurality of attributes.

6. The processing system of claim 1, wherein a first adapter of the plurality of adapters is biased to operating on earlier layers in the machine learning model over a second adapter of the plurality of adapters and wherein the second adapter is biased to operating on later layers in the machine learning model over the first adapter.

7. The processing system of claim 1, wherein at least one of the adapters has frozen weights and an output mask with learnable weights associated with the cycle-consistency loss.

8. The processing system of claim 1, wherein at least one of the adapters has learnable weights associated with the cycle-consistency loss in a rank dimension of the at least one of the adapters.

9. A processing system for machine learning, comprising:
at least one memory having executable instructions stored thereon; and
one or more processors configured to execute the executable instructions in order to cause the processing system to:
receive a first data set associated with a first attribute of an output for which a machine learning model is to be trained;
receive a second data set associated with a second attribute of the output for which the machine learning model is to be trained;
train a first adapter of the machine learning model to finetune outputs in accordance with the first attribute based on the first data set;
train a second adapter of the machine learning model to finetune outputs in accordance with the second attribute based on the second data set;
train a merged adapter based on a cycle-consistency loss between the first attribute and the second attribute, the merged adapter comprising the first adapter and the second adapter; and
deploy the machine learning model with the trained merged adapter.

10. The processing system of claim 9, wherein the first attribute comprises an object to be depicted in an image output generated by the machine learning model and wherein the second attribute comprises a style for the image output generated by the machine learning model.

11. The processing system of claim 9, wherein the cycle-consistency loss comprises a first cycle-consistency loss for a first forward and backward transformation of content with different styles and a second cycle-consistency loss for a second forward and backward transformation of style with different contents.

12. The processing system of claim 11, wherein to calculate the first cycle-consistency loss, the one or more processors are configured to cause the processing system to:
access a sample including the content with a first style;
apply a second style to the sample using the second adapter to generate a style-injected content sample;
reconstruct the sample by applying the first style to the style-injected content sample to remove the second style, using the second adapter; and
calculate the first cycle-consistency loss based on a difference between the sample and the reconstructed sample.

13. The processing system of claim 11, wherein to calculate the second cycle-consistency loss, the one or more processors are configured to cause the processing system to:
access a sample including a first content according to the style;
change the first content in the sample to a second content using the first adapter to generate a content-injected style sample;
reconstruct the sample by changing the second content in the content-injected style sample to the first content, using the first adapter; and
calculate the second cycle-consistency loss based on a difference between the sample and the reconstructed sample.

14. The processing system of claim 9, wherein at least one of the first adapter or the second adapter has frozen weights and an output mask with learnable weights associated with the cycle-consistency loss.

15. The processing system of claim 9, wherein at least one of the first adapter or the second adapter has learnable weights associated with the cycle-consistency loss in a rank dimension of the at least one of the first adapter or the second adapter.

16. A processor-implemented method for machine learning, comprising:
receiving a request to generate an output of a machine learning model, the request specifying a plurality of attributes for the output of the machine learning model;
generating a set of intermediate outputs via a plurality of adapters of the machine learning model, each respective adapter of the plurality of adapters being associated with a respective attribute of the specified plurality of attributes and being trained based on a cycle-consistency loss between different attributes of the specified plurality of attributes;
merging the set of intermediate outputs into a combined output of the plurality of adapters of the machine learning model; and
generating the output of the machine learning model based on the combined output of the plurality of adapters.

17. The method of claim 16, wherein the output of the machine learning model is an image output and wherein the plurality of attributes includes:
an object to be depicted in the image output generated by the machine learning model; and
a style of the image output generated by the machine learning model.

18. The method of claim 16, wherein the machine learning model comprises a model trained further based on one or more of a content loss or a style loss, and wherein the cycle-consistency loss comprises a first cycle-consistency loss for a first forward and backward transformation of content with different styles and a second cycle-consistency loss for a second forward and backward transformation of style with different contents.

19. The method of claim 16, wherein the cycle-consistency loss is weighted based on a defined scaling factor.

20. The method of claim 16, wherein a first adapter of the plurality of adapters is biased to operating on earlier layers in the machine learning model over a second adapter of the plurality of adapters and wherein the second adapter is biased to operating on later layers in the machine learning model over the first adapter.
